(19) United States
(12) Patent Application Publication
(10) Pub. No.: US 2001/0028354 A1
(43) Pub. Date: Oct. 11, 2001

(54) System and method for buffer clearing for use in three-dimensional rendering

(76) Inventors: Nai-Sheng Cheng, Hsin-chu City (TW); Ko-Fang Wang, Hsin-chu City (TW)

Correspondence Address: RABIN & CHAMPAGNE, PC, 1101 14TH STREET, NW, SUITE 500, WASHINGTON, DC, 20005, US

(21) Appl. No.: 09/827,182

(22) Filed: Apr. 6, 2001

(30) Foreign Application Priority Data
Apr. 7, 2000 (TW) 89106480

(51) Int. Cl. G06T 15/40; G09G 5/39

(52) U.S. Cl. 345/531; 345/422

(57) ABSTRACT

A system and method for clearing buffer for three-dimensional rendering is disclosed, which is used in a multimedia chip. The multimedia chip is used for controlling the three-dimensional rendering and accessing a memory, and the memory includes a buffer for storing depth data of a number of pixels during three-dimensional rendering. In addition, the multimedia chip includes a multimedia related circuit. The system includes a memory interface controller and a Z clearing controller. The memory interface controller is used for receiving a conventional command signal from the multimedia related circuit, and for detecting state of the memory. The Z clearing controller is employed for receiving X- and Y-coordinates of a pixel that the multimedia related circuit is to draw, and for sending a command signal to the memory interface controller, wherein the Z clearing controller performs Z clearing on the buffer when the memory is in an idle state.

This application incorporates by reference Taiwanese application Serial No. 89106480, filed on Apr. 7, 2000.

### BACKGROUND OF THE INVENTION

1. Field of the Invention

The invention relates in general to a system and method for buffer clearing for three-dimensional (3-D) rendering, and more particularly to a system and method for Z-buffer clearing in a postponed-and-distributed manner for 3-D rendering.

2. Description of the Related Art

For the years, three-dimensional rendering becomes more widely used in computers. Through three-dimensional rendering, a 3-D graphics produces realism with 3-D qualities, making users feel and enjoy the graphics as if the users were in reality. In this way, many vendors are engaging in developing fast and high quality 3-D graphics processors.

For a 3-D animation, it is implemented by displaying a series of frames. Each frame includes pixels and each of the pixels has a depth property, or Z value, that indicates where the point lies on an imaginary Z-axis, as well as X- and Y-coordinates, color, and brightness. In addition, memory for storing the Z-values is called a Z-buffer, and reference addresses of the Z-buffer may be sequential, or organized into in a memory area in a rectangle manner.

Conventionally, the Z buffer is first to be cleared each time before the rendering of a frame. The Z buffer clearing process is called Z clearing. Z clearing refers to setting all values of the Z-buffer to the Z-value indicating the deepest in the depth property, where the Z value indicating the deepest in the depth property is a constant.

Referring to FIG. 1, it illustrates a conventional waveform of the memory access signal for rendering a frame. The memory access (MA) signal indicates the memory access states. When the MA signal is at a high level, such as high level 102, it indicates the memory is in the busy state; when the MA signal is at a low level, such as low level 104, it indicates the memory is in the idle state.

Referring now to FIG. 2, it illustrates a conventional circuit for the 3-D rendering in a block diagram. In FIG. 2, a multimedia chip 200 includes a two-dimensional (2-D) engine 204 and a three-dimensional engine 206. In addition, the multimedia chip 200 accesses a memory 208.

Referring to both FIGS. 1 and 2, they are employed to illustrate operations of the conventional approach for 3-D rendering in the following. During period T1, a software driver sends a memory fill command (MFC) to the 2-D engine 204. When the 2-D engine 204 receives the MFC, the 2-D engine 204 begins to clear the Z-buffer. When the Z-buffer is being cleared, the memory is in the busy state and thus the MA signal is at the high level 102. Since Z clearing is to set the Z-buffer to the same constant, i.e. to set all the pixels to an identical depth property, it is equivalent to setting a frame to a plane with the Z-value indicating the deepest in the depth property. Therefore, the 2-D engine 204 is sufficient to achieve the Z clearing.

At time t0, the 2-D engine 204 completes Z clearing and comes to the idle state. After a while, when the software driver detects that the 2-D engine 204 is idle, the software driver sends a 3-D rendering command (3DRC) to the 3-D engine 206. Thus, during period T2, the 3-D engine 206 is to perform 3-D rendering in response to the 3DRC. Therefore, the MA signal indicates switching between the low level 104 and high level 106, i.e. the memory 208 is not only in the busy state but also in the idle state.

During period T2, there are many situations such that the memory 208 is in the idle state. For example, when 3-D engine 206 performs a rendering process, the memory 208 is idle because the rendering process consumes time in computing. In another example, when the 3-D engine 206 is to access the memory 208, the associated commands and data are first stored in a first-in first-out (FIFO) register and the 3-D engine 206 does access the memory 208 until the content of the FIFO register reaches a certain amount of commands and data. In this way, the memory 208 is idle when the content of the FIFO register has not reached the certain amount of commands and data.

The time for clearing Z buffer is included in calculating the time for drawing frames. If the time for drawing frames is long, the display of the frames becomes slow, resulting in a degradation of the 3-D rendering performance. Therefore, for increasing the 3-D rendering performance, one of the tasks that must be resolved is to reduce the time for drawing frames.

### SUMMARY OF THE INVENTION

It is therefore an object of the invention to provide a system and method for buffer clearing for three-dimensional (3-D) rendering. According to the invention, Z clearing for a buffer of a memory is postponed to periods when the memory is idle so that the time for rendering a frame, as well as drawing a frame, is reduced. In this way, by using the invention, 3-D rendering performance is enhanced.

According to the object of the invention, it provides a system for buffer clearing for three-dimensional rendering, which is used in a multimedia chip. The multimedia chip is used for controlling the three-dimensional rendering and accessing a memory which includes a buffer for storing depth data of a number of pixels during the three-dimensional rendering, and the multimedia chip includes a multimedia related circuit. The system includes a memory interface controller and a Z clearing controller. The memory interface controller is used for receiving a conventional command signal from the multimedia related circuit, and for detecting state of the memory. The Z clearing controller is employed for receiving X- and Y-coordinates of a pixel that the multimedia related circuit is to draw, and for sending a command signal to the memory interface controller, wherein the Z clearing controller performs Z clearing on the buffer when the memory is in an idle state.

According to the object of the invention, it provides a system for buffer clearing for three-dimensional rendering, which is used in a multimedia chip. The multimedia chip is used for controlling the three-dimensional rendering and accessing a memory which includes a Z buffer for storing depth data of a number of pixels during the three-dimensional rendering, and the multimedia chip including a multimedia related circuit which includes a three-dimensional engine. The system includes a memory interface controller and a Z clearing controller. The memory interface controller is used for receiving a conventional command signal from the multimedia related circuit, and for detecting state of the memory. The Z clearing controller, which is used for sending a command signal to the memory interface controller, includes a Z clearing tag register, an index selecting unit, and a starting address storage unit. The Z clearing tag register has M tags which are associated with M indexes, wherein the Z buffer is divided into M segments which are associated with the M tags. The index selecting unit is employed for receiving X- and Y-coordinates of a pixel that the three-dimensional engine is to draw and obtaining one of the indexes by using the X- and Y-coordinates of the pixel. The starting address storage unit is utilized for storing an address of the Z buffer. When the memory is in an idle state, the Z clearing controller performs Z clearing on the segments of the Z buffer. When Z clearing for one of the M segments is complete, one of the tags associated with the one of the M segments is set to a first value; if not, the one of the tags associated with the one of the M segments is set to a second value. When Z clearing for the one of the M segments is incomplete, the one of the M segments has a portion on which Z clearing is not performed, and a beginning address of the portion is stored in the starting address storage unit.

According to the object of the invention, it provides a buffer clearing method, for use in three-dimensional rendering. The buffer clearing method is used for performing Z clearing on a Z buffer of a memory, wherein the Z buffer is used for storing depth data of a number of pixels, the Z buffer is divided into M segments which are associated with M tags, and the memory is responsive to a conventional command signal for accessing the memory from a multimedia related circuit. In addition, when the multimedia related circuit does not send the conventional command signal to the memory, the memory is in an idle state. The buffer clearing method includes the following steps. (a) When the memory is in the idle state, Z clearing is performed on the segment associated with one of the tags which has a first value. (b) If the conventional command signal is sent to the memory, the method proceeds to step (c); if not, step (a) is repeated. (c) Z clearing is stopped. (d) If Z clearing for the segment is complete, a value of the tag associated with the segment is set to a second value; if not, the value of the tag is kept in the first value. (e) Steps (a) to (e) are repeated until Z clearing for the M segments is complete.

According to the object of the invention, it provides a pixel drawing method for use in three-dimensional rendering. The pixel drawing method is used for performing drawing for a number of pixels P which are associated with a Z buffer of a memory. In addition, the Z buffer is used for storing the pixels' depth data during the three-dimensional rendering, and is divided into M segments S. Further, each of the pixels P(x, y) is associated with one of the M segments S(i), and the M segments are associated with M tags TAG respectively. When the memory is idle, Z clearing is performed on the Z buffer, and when Z clearing for the segment S(i) is complete, the tag TAG(i) associated with the segment S(i) is set to a first value. The pixel drawing method includes the following steps. (a) By using the X- and Y-coordinates of the pixel P(x, y), the segment S(i) associated with the pixel P(x, y) is obtained, and the value of the tag TAG(i) associated with the segment S(i) is then obtained. (b) When the value of the tag TAG(i) is equal to the first value, step (c) is to be performed; otherwise, step (d) is to be performed. (c) Perform three-dimensional rendering for the pixel P(x, y) and repeat from step (a) until all of the pixels are drawn. (d) Generate an internal lock signal, perform Z clearing on the segment S(i) completely, and repeat from step (c), wherein the internal lock signal indicates that Z clearing for the segment S(i) associated with the pixel P(x, y) to be drawn is incomplete.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) is a memory access waveform illustrating rendering a frame by using the conventional rendering method;

FIG. 2 (Prior Art) is a block diagram of hardware related to conventional three-dimensional (3-D) rendering;

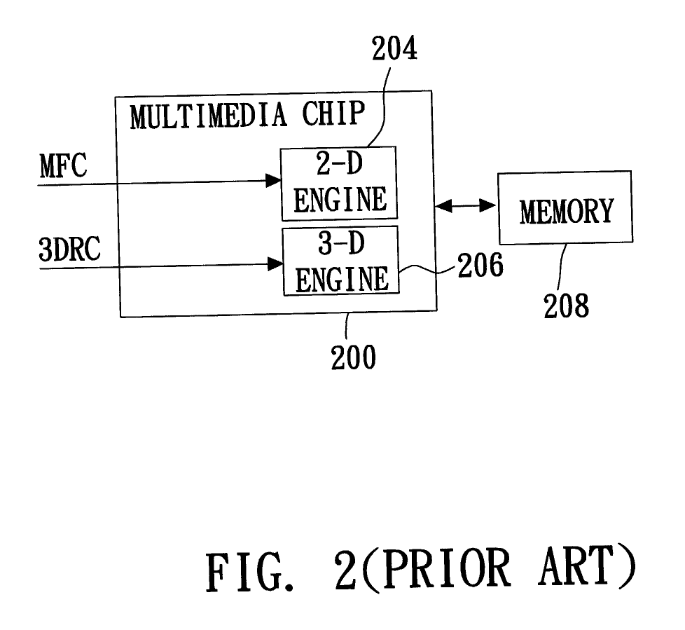

FIG. 3 is a block diagram of a system for clearing buffer, for use in 3-D rendering, according to a preferred embodiment of the invention;

FIG. 4 illustrates the relationship between a frame, Z clearing tag register, and Z buffer according to the preferred embodiment of the invention;

FIG. 5 is a flowchart of a Z-buffer clearing method for use in 3-D rendering according to the preferred embodiment of the invention;

FIG. 6 is a flowchart of a pixel drawing method according to the preferred embodiment of the invention; and

FIG. 7 is a memory access waveform according to the preferred embodiment of the invention.

### DESCRIPTION OF THE PREFERRED EMBODIMENT

According to the invention, the performance and processing rate of three-dimensional (3-D) rendering is enhanced by postponing Z clearing to the periods when memory for rendering is idle, so that 3-D rendering performs rapidly with reduced time for drawing a frame. In addition, a Z buffer of the memory is divided into a number of segments and Z clearing is performed on one segment or more segments during the memory is idle.

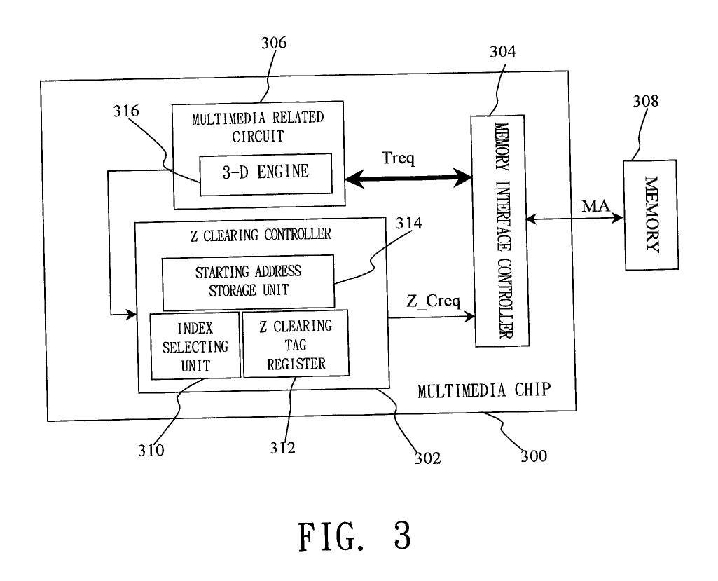

Referring to FIG. 3, it illustrates a block diagram of a system for Z-buffer clearing for 3-D rendering according to a preferred embodiment of the invention. In FIG. 3, multimedia chip 300, for use in a computer system (not shown), is used for controlling monitor display in the computer system, controlling graphics data, or processing audio data. According to the invention, the multimedia chip 300 includes a Z clearing controller 302, a memory interface controller 304, and a multimedia related circuit 306. The Z clearing controller 302 includes an index selecting unit 310, a Z clearing tag register 312, and a starting address storage unit 314. The multimedia related circuit 306 is employed to perform multimedia audio and video computation and controlling and includes a 3-D engine 316, a 2-D engine (not shown), a video engine (not shown), a video controller (not shown), and an audio controller (not shown).

The multimedia related circuit 306 sends a conventional command signal, Treq, to the memory interface controller 304. For instance, the multimedia related circuit 306 sends a signal such as write command signal, read command signal, read data signal, or write data signal to memory 308 outside the multimedia chip 300. In addition, the multimedia related circuit 306 further sends the command and data signals to the Z clearing controller 302 and receives a control signal received from a software driver. The Z clearing controller 302 is employed to send a Z clearing command signal, Z_Creq, to the memory interface controller 304. For accessing the memory 308, the memory interface controller 304 is used for sending a memory access signal MA to the memory 308 which can be inside the multimedia chip 300.

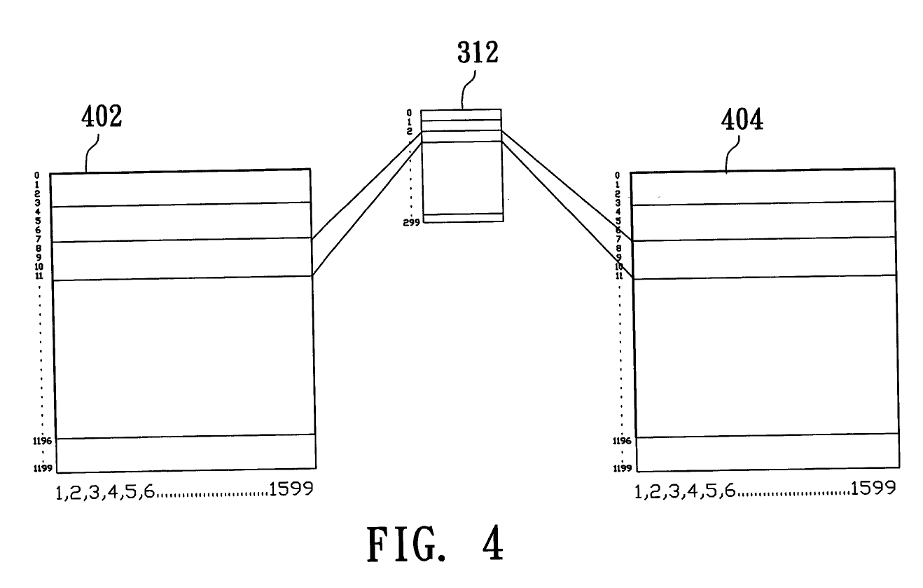

Referring to FIG. 4, it illustrates the relationship between a frame, Z clearing tag register, and Z buffer according to the preferred embodiment of the invention. According to the invention, the Z buffer is to be divided into a number of segments. In FIG. 4, one partitioning approach is shown for the sake of illustration. It should be noted that this partitioning approach is just an example and any approach other than this approach can be used for partitioning the Z buffer.

Supposed that a frame 402 which the 3-D engine 316 is to draw has 1600 by 1200 pixels, the X-coordinates of these pixels are numbered from 0 to 1599, the Y-coordinates of these pixels are numbered from 0 to 1199, and there are 1200 rows and 1600 columns totally. In the multimedia chip 300, these coordinates are represented by 11-bit binary numbers. For a pixel P(x, y), it represents that the X- and Y-coordinates of the pixel P are x and y respectively. In addition, each pixel is associated with a unit of the Z buffer 404 of the memory 308. For instance, the pixel P(x, y) is associated with a unit M(x, y) of the Z buffer 404.

For instance, every four rows in the Z buffer 404 are taken as one segment. In this way, the Z buffer 404 has 1200/4=300 segments, each of which is denoted as S(i) and, correspondingly, the Z clearing tag register 312 has 300 tags, each of which is denoted as TAG(i), where index i is an integer of 0 to 299. In terms of the notations, S(i) is associated with TAG(i) and S(i) consists of the units M(x, 4i), M(x, 4i+1), M(x, 4i+2), and M(x, 4i+3) of the Z buffer 404. For instance, segment S(0) consists of the units M(x, 0) to M(x, 3) of the Z buffer, and segment S(1) consists of the units M(x, 4) to M(x, 7), where x is an integer of 0 to 1599.

Following from the above, when TAG(i) is set to a first value, it indicates the S(i) of the Z buffer 404 is cleared, i.e. Z clearing for the segment S(i) is complete. On the other hand, when TAG(i) is set to a second value, it indicates the S(i) of the Z buffer 404 is not cleared or being cleared, i.e. Z clearing for the segment S(i) is incomplete. Initially, the values of tags for the segments S(0) to S(299) are all set to the first value. In practice, the first and second values can be defined as two different numbers respectively, such as one and zero, or zero and one. In the embodiment, the first value is defined as one and the second value is defined as zero. In addition, Z clearing or clearing Z buffer represents setting the value of unit M(x, y) of the Z buffer 404 to be a maximum depth value.

In order to reduce the time for drawing a frame, Z clearing is postponed to the periods when the memory 308 is idle. In FIG. 3, when the memory interface controller 304 detects that the memory 308 is idle, the memory interface controller 304, in response to a Z clearing command signal Z_Creq sent by the Z clearing controller 302, clears the Z buffer 404 of the memory 308 until the memory interface controller 304, in response to a conventional command signal Treq sent by the multimedia related circuit 306, is to access the memory 308. When the segment S(i) of the Z buffer 404 is cleared, or Z clearing for the segment S(i) is complete, the TAG(i) in the Z clearing tag register 312 is changed from zero to one. On the other hand, when the segment S(i) of the Z buffer 404 is not cleared completely, the TAG(i) remains being zero and the address of the beginning unit M(x, y) of a portion in the segment S(i) on which Z clearing for the segment S(i) is incomplete is stored in a starting address storage unit 314. Afterwards, when the memory 308 is idle, the Z clearing controller 304 reads the value of the starting address storage unit 314 and then performs Z clearing on the unit M(x, y) associated with the value.

As described above, Z clearing for the Z buffer is performed when the memory is idle. As an example of the sequence of Z clearing, Z clearing is performed on the segment S(i) of the Z buffer 404 for i=0 to 299 sequentially. For this example of the sequence of Z clearing, it should be aware that it is not to give any limitation to the invention. According to the invention, another sequence of Z clearing is also included in the scope of the invention.

In FIG. 4, when 3-D rendering is performed on pixel P(x, y), it should confirm that Z clearing for the unit M(x, y) of the Z buffer 404 associated with the pixel P(x, y) is complete. In FIG. 3, when the 3-D engine 316 sends X- and Y-coordinates of the pixel P(x, y) to the Z clearing controller 302, the Z clearing controller 302 obtains the index i associated with the pixel P(x, y) from the index selecting unit 310 and then reads the value of TAG(i) from the Z clearing tag register 312. When the value of TAG(i) is zero, it indicates the segment S(i) of the Z buffer 404 associated with the TAG(i) is not cleared completely or is being cleared. Then, the multimedia chip 300 stops rendering the pixel P(x, y) and the Z clearing controller 302 sends an internal lock signal, Int_lock, to the memory interface controller 304 for performing Z clearing for the entire segment S(i). When Z clearing for the segment S(i) is complete and the associated TAG(i) is set to one, the 3-D engine 316 performs rendering of the pixel P(x, y).

Besides, in specific conditions, during the 3-D engine 316 performs rendering, direct access to the Z buffer 404 is necessary. For instance, when the central processing unit (CPU) (not shown) of the computer system requires accessing the entire Z buffer 404 directly, a detecting circuit (not shown) inside the multimedia chip 300 detects the access requirement and generates an external lock signal, Ext_lock, for clearing the Z buffer 404. During clearing the Z buffer 404, Z clearing may be performed on the entire Z buffer 404, or only the segment which includes an address that the CPU requires accessing, or only the portion in the Z buffer 404 on which Z clearing is not completely performed.

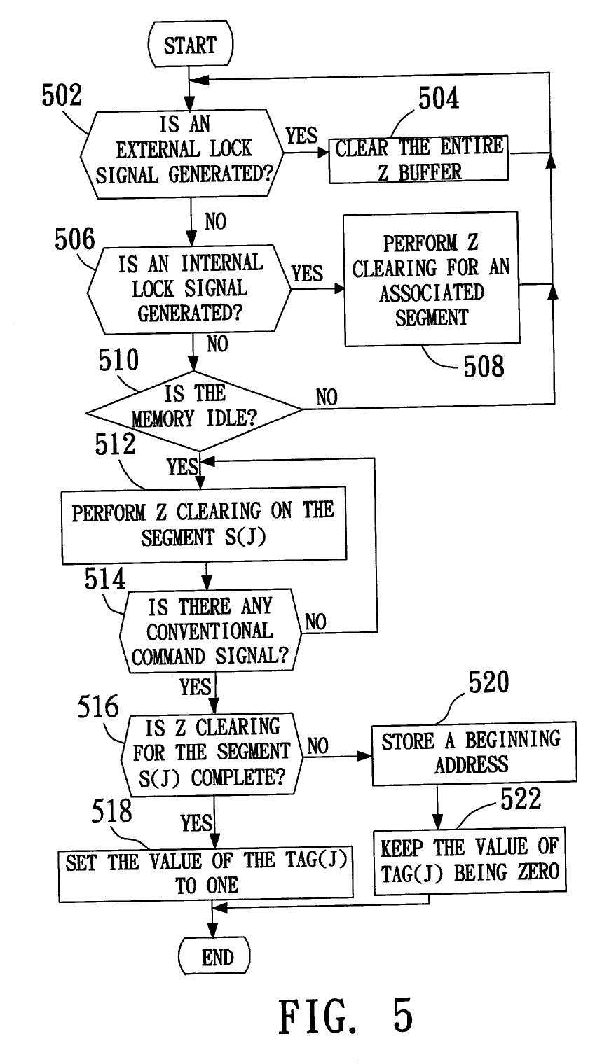

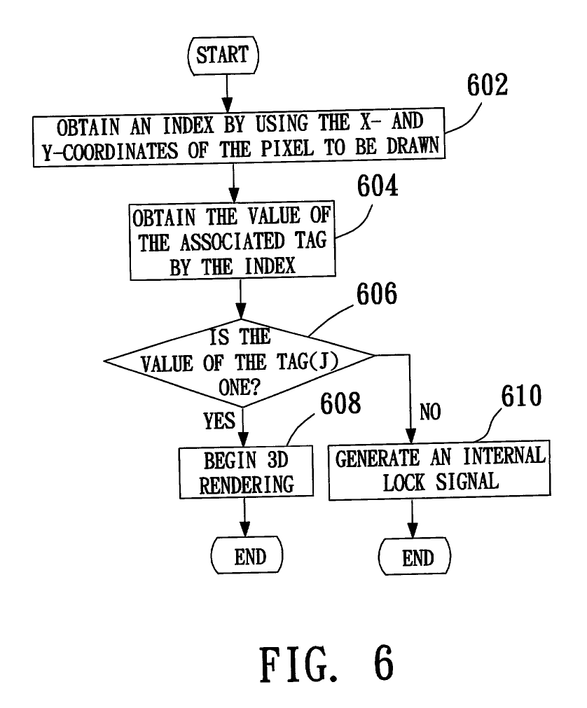

For the sake of understanding of the invention, referring now to FIGS. 5 and 6, they respectively illustrates the flowcharts of a buffer clearing method for 3-D rendering and a pixel drawing method according to the preferred embodiment of the invention.

In FIG. 5, the clearing buffer method begins and proceeds to step 502 to determine whether an external lock signal, Ext_lock, is generated. If it is determined that the external lock signal is generated, the method proceeds to step 504 for performing Z clearing for the entire Z buffer. If not, the method proceeds to step 506. In step 506, a determination is made whether an internal lock signal, Int_lock, is generated. If the internal lock signal is generated, the method proceeds to 508 to performing Z clearing for an associated segment. Otherwise, the method proceeds to step 510. In step 510, it is determined whether the memory 308 is idle. If it is idle, the method proceeds to step 512; otherwise, repeating step 502.

In step 512, Z clearing begins. That is, Z clearing is performed on the segment S(j) associated with the tag TAG(j) with a value of zero, where j is an integer of 0 to 299. When performing Z clearing, it is not necessary to clear the entire segment S(j) at a time. Alternatively, a portion of the segment S(j), such as a portion of 100 pixels for the segment S(j), may be cleared at a time. In this way, during Z clearing, the segment S(j) to be cleared may have been cleared for a certain number of pixels, such as 50%, or may be completely not cleared. When the tag TAG(j) has a value of zero and the starting address storage unit 314 is not empty, it indicates that the segment S(j) has been cleared incompletely. Thus, when Z clearing is performed on the segment S(j) in the next time, Z clearing only needs to start at the address value stored in the starting address storage unit 314.

After performing step 512, the method proceeds to step 514 for determining whether any conventional command signal Treq is sent to the memory interface controller 304. If a conventional command signal Treq is sent to the memory interface controller 304, it indicates that the multimedia related circuit 306 is to access the memory 308, and the method proceeds to step 516. If not, step 512 is repeated. In step 516, Z clearing is stopped and a determination is made whether Z clearing for the segment S(j) is complete. If so, the method proceeds to step 518. If not, the method proceeds to step 520. In step 518, due to the completion of Z clearing for the segment S(j), the associated TAG(j) is set to one. In step 520, because Z clearing for the segment S(j) is not complete, a beginning address of a portion of the segment S(j) on which Z clearing is not performed is stored in the starting address storage unit 314. In this way, next time when Z clearing for the segment S(j) is performed, the beginning address stored in the starting address storage unit 314 is read and used as the starting address for Z clearing for the segment S(j). After performing step 520, the method proceeds to step 522 to keep TAG(j) being zero.

Referring now to FIGS. 3 and 6, when the multimedia related circuit 306 draws pixel P(x₀, y₀), the 3-D engine 316 sends the X- and Y-coordinates of the pixel P(x₀, y₀) to the Z clearing controller 302, and then the method proceeds to step 602. In step 602, the index selecting unit 310 processes the X- and Y-coordinates of the pixel P(x₀, y₀), resulting in an index j associated with the pixel P(x₀, y₀). Then, the method proceeds to step 604 where the value of the associated TAG(j) is obtained. Next, step 606 is performed, where a determination is made whether the value of the TAG(j) is one. If so, it indicates that Z clearing for the segment S(j) of the Z buffer associated with the TAG(j) is complete, and the method then proceeds to step 608 to begin rendering the pixel P(x₀, y₀). If not, it indicates that Z clearing for the segment S(j) of the Z buffer associated with the TAG(j) is incomplete, and the method then proceeds to step 610 to generate the internal lock signal Int_lock.

Referring to FIGS. 5 and 6, after generating the internal lock signal Int_lock in step 608, the signal Int_lock is detected in step 506 and thus the method proceeds to step 508 to clear the segment S(j) of the Z buffer 404. If the pixel P(x₀, y₀) is to be drawn, Z clearing for the unit M(x₀, y₀) of the buffer 404 which is associated with the pixel P(x₀, y₀) must be complete first. In this way, when the 3-D engine 316 begins to draw the pixel P(x₀, y₀) and the unit M(x₀, y₀) of the buffer 404 which is associated with the pixel P(x₀, y₀) is not cleared completely, the Z clearing controller 302 generates the internal lock signal Int_lock. Then, the method proceeds to step 508 to perform Z clearing on the segment S(j) associated with the pixel P(x₀, y₀) so that the pixel P(x₀, y₀) is drawn properly.

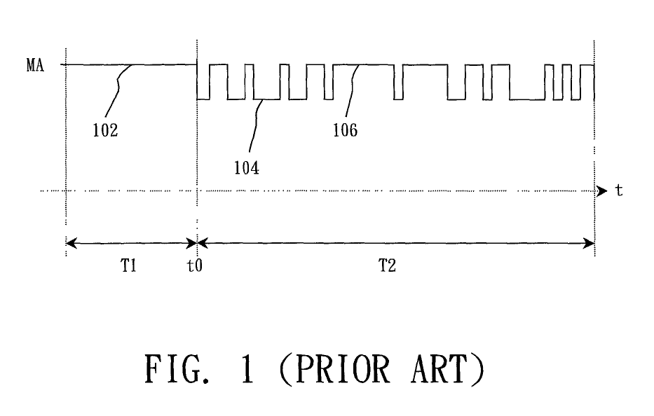

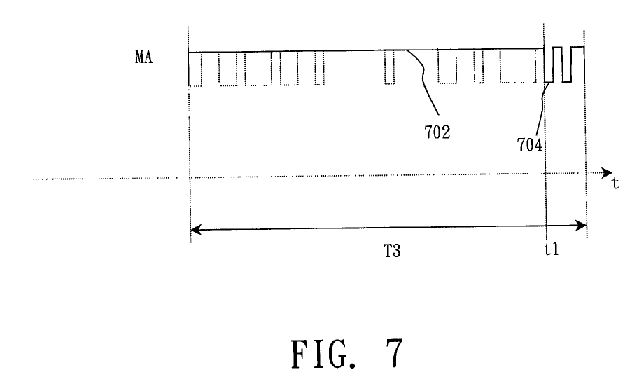

Referring now to FIG. 7, it illustrates a waveform illustrating a memory access signal according to the preferred embodiment of the invention. In FIG. 7, the dotted line represents the memory access signal waveform in conventional 3-D rendering as shown in FIG. 1 and the black line represents the memory access signal waveform according to the invention. In period T3, the 3-D engine 316 performs 3-D rendering. In FIG. 7, when the memory access (MA) signal is in high level 702, it indicates that the memory interface controller 304 is accessing the memory 308. When the MA signal is in low level 704, it indicates that the memory interface controller 304 does not access the memory 308, i.e. the memory 308 is in an idle state, and, according to the invention Z clearing is performed on the Z buffer 404 when the memory 308 is the idle state. As illustrated in FIG. 7, before period t1, Z clearing is complete since it is postponed to the periods when the memory 308 is regarded as being in the idle state in the conventional approach. In this way, when 3-D rendering is performed, the memory 308 is utilized more effectively, resulting in a reduction of the time spent for drawing a frame and an increase in the speed of frame drawing.

Therefore, by using the system and method for buffer clearing for 3-D rendering according to the invention, Z clearing is postponed to the periods when the memory is idle, reducing the time for frame drawing and thus enhancing the performance and quality of 3-D rendering.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A system for buffer clearing for three-dimensional rendering, the system used in a multimedia chip, the multimedia chip being for controlling the three-dimensional rendering and accessing a memory, the memory including a buffer for storing depth data of a plurality of pixels during the three-dimensional rendering, and the multimedia chip including a multimedia related circuit, the system comprising:
a memory interface controller for receiving a conventional command signal from the multimedia related circuit, and for detecting state of the memory; and
a Z clearing controller for receiving X- and Y-coordinates of a pixel that the multimedia related circuit is to draw, and for sending a command signal to the memory interface controller, wherein the Z clearing controller performs Z clearing on the buffer when the memory is in an idle state.

2. A system according to claim 1, wherein the buffer is divided into M segments and the pixels are associated with the M segments.

3. A system according to claim 2, wherein the M segments of the buffer are further associated with M tags, and when Z clearing for one of the M segments is complete, one of the M tags which is associated with the one of the M segment is set to a first value.

4. A system according to claim 3, wherein the first value is one.

5. A system according to claim 3, wherein the first value is zero.

6. A system according to claim 3, wherein the Z clearing controller comprises an index selecting unit.

7. A system according to claim 6, wherein the index selecting unit is used for receiving the X- and Y-coordinates of the pixel that the multimedia related circuit is to draw, and for obtaining one of M indexes by using the X- and Y-coordinates of the pixel that the multimedia related circuit is to draw.

8. A system according to claim 7, wherein the M tags are associated with the M indexes.

9. A system according to claim 3, further comprising a starting address storage unit, wherein when Z clearing for one of the M segments is incomplete, the segment has a portion on which Z clearing is not performed, and a beginning address of the portion is stored in the starting address storage unit and is used as a starting address for Z clearing when Z-clearing is to be performed on the one of the M segments afterwards

10. A system according to claim 1, wherein the command signal is a Z clearing command signal.

11. A system according to claim 1, wherein the memory is inside the multimedia chip.

12. A system according to claim 1, wherein the memory is outside the multimedia chip.

13. A system according to claim 1, wherein the buffer is a Z buffer.

14. A system according to claim 1, wherein when the memory is in the idle state, Z clearing is performed on one of the M segments of the buffer, or a plurality of segments of the M segments of the buffer, or a portion of one of the M segments of the buffer.

15. A system for buffer clearing for three-dimensional rendering, the system used in a multimedia chip, the multimedia chip being for controlling the three-dimensional rendering and accessing a memory, the memory including a Z buffer for storing depth data of a plurality of pixels during the three-dimensional rendering, and the multimedia chip including a multimedia related circuit which includes a three-dimensional engine, the system comprising:
a memory interface controller for receiving a conventional command signal from the multimedia related circuit, and for detecting state of the memory; and
a Z clearing controller for sending a command signal to the memory interface controller, comprising:
a Z clearing tag register having M tags which are associated with M indexes, wherein the Z buffer is divided into M segments which are associated with the M tags;
an index selecting unit for receiving X- and Y-coordinates of a pixel that is to be drawn by the three-dimensional engine and obtaining one of the indexes by using the X- and Y-coordinates of the pixel; and
a starting address storage unit for storing an address of the Z buffer;
wherein the Z clearing controller performs Z clearing on the Z buffer when the memory is in an idle state; when Z clearing for one of the segments is complete, one of the tags associated with the one of the segments is set to a first value; if not, the one of the tags associated with the one of the segments is set to a second value; and when Z clearing for the one of the segments is incomplete, the one of the segments has a portion on which Z clearing is not performed, and a beginning address of the portion is stored in the starting address storage unit.

16. A system according to claim 15, wherein the first value is one and the second value is zero.

17. A system according to claim 15, wherein the first value is zero and the second value is one.

18. A system according to claim 15, wherein the conventional command signal from the multimedia related circuit includes at least one of a write command signal, read command signal, write data signal, and read data signal.

19. A buffer clearing method, for use in three-dimensional rendering, for performing Z clearing on a Z buffer of a memory, the Z buffer being used for storing depth data of a plurality of pixels and being divided into M segments which are associated with M tags, the memory being responsive to a conventional command signal for accessing the memory from a multimedia related circuit, wherein when the multimedia related circuit does not send the conventional command signal to the memory, the memory is in an idle state, the buffer clearing method comprising the steps of:
(a) performing Z clearing on the segment associated with one of the tags which has a first value when the memory is in the idle state;
(b) proceeding to step (c) if the conventional command signal is sent to the memory, and repeating said step (a) if no conventional command signal is sent to the memory;
(c) stopping Z clearing;
(d) setting a value of the tag associated with the segment to a second value if Z clearing for the segment is complete; keeping the value of the tag associated with the segment being the first value if Z clearing for the segment is incomplete; and
(e) repeating from said step (a) to step (e) until Z clearing for the M segments is complete.

20. A buffer clearing method according to claim 19, wherein the first value is zero and the second value is one.

21. A buffer clearing method according to claim 19, wherein the first value is one and the second value is zero.

22. A buffer clearing method according to claim 19, between said step (d) and step (e), further comprising the step of:
(d1) storing a beginning memory address of a portion in the segment on which Z clearing has not performed in a starting address storage unit when Z clearing for the segment is incomplete, wherein the beginning memory address is used as a starting address when Z clearing for the segment is performed afterwards.

23. A buffer clearing method according to claim 19, before said step (a), further comprising the step of:
(a1) performing Z clearing on the Z buffer when an external lock signal is generated, wherein the external lock signal indicates that the Z buffer is to be accessed.

24. A buffer clearing method according to claim 23, wherein performing Z clearing in said step (a1) comprises:
performing Z clearing on the Z buffer completely, or performing Z clearing on a portion of the Z buffer to be accessed, or performing Z clearing on a portion of the Z buffer on which Z clearing has not been performed.

25. A buffer clearing method according to claim 19, before said step (a), further comprising the step of:
(a1) performing Z clearing on the segment completely when an internal lock signal is generated, wherein the internal lock signal indicates that the pixels associated with the segment are to be drawn.

26. A pixel drawing method for use in three-dimensional rendering, for performing drawing for a plurality of pixels P, the pixels P being associated with a Z buffer of a memory, the Z buffer being used for storing the pixels' depth data during the three-dimensional rendering, the Z buffer being divided into M segments S, each of the pixels P(x, y) being associated with one of the M segments S(i), the M segments being further associated with M tags TAG respectively, wherein when the memory is idle, Z clearing is performed on the Z buffer, and when Z clearing for the segment S(i) is complete, a value of a tag TAG(i) associated with the segment S(i) is set to a first value, the pixel drawing method comprising the steps of:
(a) obtaining the segment S(i) which is associated with the pixel P(x, y) by using the X- and Y-coordinates of the pixel P(x, y), and obtaining the value of the tag TAG(i) associated with the segment S(i);
(b) proceeding to step (c) when the value of the tag TAG(i) is equal to the first value; otherwise, proceeding to step (d);
(c) performing three-dimensional rendering for the pixel P(x, y) and repeating from said step (a) until all of the pixels P are drawn; and
(d) generating an internal lock signal and performing Z clearing on the segment S(i) completely, and repeating from said step (c), wherein the internal lock signal indicates that Z clearing for the segment S(i) associated with the pixel P(x, y) to be drawn is incomplete.

27. A pixel drawing method according to claim 26, wherein the first value is one.

28. A pixel drawing method according to claim 26, wherein the first value is zero.
